(19) United States
(12) Patent Application Publication
(10) Pub. No.: US 2026/0113130 A1
(43) Pub. Date: Apr. 23, 2026

(54) SIDELINK SYNCHRONIZATION SIGNAL TRANSMISSION

(71) Applicant: QUALCOMM Incorporated, San Diego, CA (US)

(72) Inventors: Shijun WU, San Diego, CA (US); Hong CHENG, Basking Ridge, NJ (US); Kapil GULATI, Belle Mead, NJ (US)

(21) Appl. No.: 18/920,369

(22) Filed: Oct. 18, 2024

(51) Int. Cl. H04B 17/318; H04W 24/02

(52) U.S. Cl. CPC H04B 17/328; H04W 24/02

(57) ABSTRACT

Various aspects of the present disclosure generally relate to wireless communication. In some aspects, a user equipment (UE) may receive, from a network node, a sidelink configuration indicating a set of candidate reference signal received power (RSRP) values for a threshold. The UE may select an RSRP value for the threshold from the set of candidate RSRP values based at least in part on an output from an artificial intelligence or machine learning (AI/ML) model. The UE may transmit a sidelink synchronization signal block (SSB) based at least in part on an RSRP measurement associated with a cell satisfying the threshold associated with the selected RSRP value. Numerous other aspects are described.

### FIELD OF THE DISCLOSURE

Aspects of the present disclosure generally relate to wireless communication and specifically relate to techniques, apparatuses, and methods associated with sidelink synchronization signal transmission.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to receive, from a network node, a sidelink configuration indicating a set of candidate reference signal received power (RSRP) values for a threshold. The one or more processors may be configured to select an RSRP value for the threshold from the set of candidate RSRP values based at least in part on an output from an artificial intelligence or machine learning (AI/ML) model. The one or more processors may be configured to transmit a sidelink synchronization signal block (SSB) based at least in part on an RSRP measurement associated with a cell satisfying the threshold associated with the selected RSRP value.

Some aspects described herein relate to a network node for wireless communication. The network node may include one or more memories and one or more processors coupled to the one or more memories. The one or more processors may be configured to identify a set of candidate RSRP values for a threshold related to a sidelink SSB transmission. The one or more processors may be configured to transmit, to a UE, a sidelink configuration indicating the set of candidate RSRP values.

Some aspects described herein relate to a method of wireless communication performed by a UE. The method may include receiving, from a network node, a sidelink configuration indicating a set of candidate RSRP values for a threshold. The method may include selecting an RSRP value for the threshold from the set of candidate RSRP values based at least in part on an output from an AI/ML model. The method may include transmitting a sidelink SSB based at least in part on an RSRP measurement associated with a cell satisfying the threshold associated with the selected RSRP value.

Some aspects described herein relate to a method of wireless communication performed by a network node. The method may include identifying a set of candidate RSRP values for a threshold related to a sidelink SSB transmission. The method may include transmitting, to a UE, a sidelink configuration indicating the set of candidate RSRP values.

Some aspects described herein relate to a non-transitory computer-readable medium that stores a set of instructions for wireless communication by a UE. The set of instructions, when executed by one or more processors of the UE, may cause the UE to receive, from a network node, a sidelink configuration indicating a set of candidate RSRP values for a threshold. The set of instructions, when executed by one or more processors of the UE, may cause the UE to select an RSRP value for the threshold from the set of candidate RSRP values based at least in part on an output from an AI/ML model. The set of instructions, when executed by one or more processors of the UE, may cause the UE to transmit a SSB based at least in part on an RSRP measurement associated with a cell satisfying the threshold associated with the selected RSRP value.

Some aspects described herein relate to a non-transitory computer-readable medium that stores a set of instructions for wireless communication by a network node. The set of instructions, when executed by one or more processors of the network node, may cause the network node to identify a set of candidate RSRP values for a threshold related to a sidelink SSB transmission. The set of instructions, when executed by one or more processors of the network node, may cause the network node to transmit, to a UE, a sidelink configuration indicating the set of candidate RSRP values.

Some aspects described herein relate to an apparatus for wireless communication. The apparatus may include means for receiving, from a network node, a sidelink configuration indicating a set of candidate RSRP values for a threshold. The apparatus may include means for selecting an RSRP value for the threshold from the set of candidate RSRP values based at least in part on an output from an AI/ML model. The apparatus may include means for transmitting a sidelink SSB based at least in part on an RSRP measurement associated with a cell satisfying the threshold associated with the selected RSRP value.

Some aspects described herein relate to an apparatus for wireless communication. The apparatus may include means for identifying a set of candidate RSRP values for a threshold related to a sidelink SSB transmission. The apparatus may include means for transmitting, to a UE, a sidelink configuration indicating the set of candidate RSRP values.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example architecture of a functional framework for radio access network intelligence enabled by data collection, in accordance with the present disclosure.

FIG. 4 is a diagram illustrating an example of sidelink communications, in accordance with the present disclosure.

FIG. 5 is a diagram illustrating examples of sidelink communications in different coverage scenarios, in accordance with the present disclosure.

FIG. 6 is a diagram illustrating examples of sidelink communications, in accordance with the present disclosure.

FIG. 7 and FIGS. 8A-8B are diagrams illustrating examples associated with sidelink synchronization signal transmission, in accordance with the present disclosure.

FIG. 9 is a diagram illustrating an example of an artificial intelligence or machine learning based model for determining a reference signal received power threshold value, in accordance with the present disclosure.

FIG. 10 is a diagram illustrating an example process performed, for example, at a user equipment (UE) or an apparatus of a UE, in accordance with the present disclosure.

FIG. 11 is a diagram illustrating an example process performed, for example, at a network node or an apparatus of a network node, in accordance with the present disclosure.

FIGS. 12-13 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, a user equipment (UE) may be in communication with a network node to facilitate the communication of voice, text, data, video, and/or other traffic between the UE and the network node. During the process of establishing a connection between the UE and the network node, the UE may be synchronized with the network node (e.g., synchronization of timing and/or frequency reference) to ensure efficient resource allocation and maintain quality of service.

Additionally, two or more UEs may communicate directly with one another using sidelink communications (e.g., via a sidelink protocol), which enables direct communication between the UEs without utilizing the network node as an intermediary. Where the UEs are connected via a sidelink protocol, one UE (referred to as a transmit (Tx) UE) may transmit communications to the other UE (referred to as a receive (Rx) UE) via the sidelink protocol. Additionally, sidelink communications between a Tx UE and a Rx UE may need to be synchronized in order to align the time and frequency references between the two UEs. For example, where the Tx UE and the Rx UE are each associated with (e.g., connected to) the same network node, each UE being synchronized with the network node results in the Tx UE and the Rx UE being indirectly synchronized with each other.

However, where a Tx UE and a Rx UE are associated with different, asynchronous network nodes (e.g., network nodes that are not synchronized with each other), the Tx UE and the Rx UE may synchronize with each other via a sidelink synchronization signal (e.g., a sidelink synchronization signal block (SSB)). For example, the sidelink SSB may be transmitted from the Tx UE to the Rx UE. Additionally, or alternatively, the sidelink signal may be transmitted by another UE to the Rx UE, as sidelink signal transmission and data channel transmission can be decoupled.

Additionally, where one of the UEs communicating via the sidelink protocol (e.g., the Tx UE or the Rx UE) is outside of the coverage of a network node and the other UE is within the coverage of a network node, known as a partial coverage scenario, the UE within the coverage of the network node may transmit the sidelink SSB to propagate the timing and frequency reference of the network node to the out-of-coverage UE, so that both UEs may be synchronized and communicate via the sidelink protocol.

However, it may be inefficient for a UE to transmit the sidelink SSB in certain circumstances, such as the UE being located within or near the center of cell coverage of a network node. Rather, it may be more efficient for a UE to transmit the sidelink SSB only if the UE is located within a sufficient proximity of the cell edge of the network node. For example, UEs that receive the sidelink SSB from a UE in a cell center may also be located within or near the cell center, and thus may obtain synchronization information directly from the network node. In contrast, UEs that receive the sidelink SSB from a UE in the cell edge area are more likely to be out-of-coverage of the network node. The cell edge may be determined by a reference signal received power (RSRP) threshold that is configured by the network node. For example, if a UE measures an RSRP that satisfies (e.g., is below) the configured RSRP threshold, the UE may be considered at the cell edge and may transmit the sidelink SSB.

However, because the RSRP threshold is a fixed or static value configured by the network node, the RSRP threshold value may not reflect the actual cell shape and/or cell coverage of a network node. For example, the cell shape and/or cell coverage of a network node may be amorphous and may vary depending on the location and/or time. Accordingly, the fixed or static RSRP threshold value configured by the network node may not accurately represent the actual cell edge, resulting in inefficient utilization of sidelink communications. For example, where a UE obtains an RSRP measurement that satisfies the RSRP threshold, but the UE is located in the center of a cell provided by the network node, the UE may unnecessarily transmit the sidelink SSB. These transmissions may result in increased power consumption in the UE and increased network traffic, resulting in increased network congestion and/or interference.

Various aspects relate generally to a network node configuring a set of candidate RSRP threshold values from which a UE may select the RSRP value to be used in determining whether to transmit sidelink SSB. Some aspects more specifically relate to the network node indicating a range of candidate RSRP threshold values or indicating an enumerated set of RSRP threshold values. In some aspects, the candidate RSRP threshold values may be cell-specific. In some aspects, the network node may transmit the configuration of the candidate RSRP threshold values to the UE via a cell-specific message or via a UE-dedicated message. In some aspects, the candidate RSRP threshold values may be received by the UE as part of a configuration from an operation, administration, and maintenance (OAM) entity. In some aspects, the candidate RSRP threshold values may be determined by the network node based on UE reports of measured RSRP values. In some aspects, the UE may select the RSRP threshold value from the set of candidate RSRP threshold values based on an output from an artificial intelligence or machine learning (AI/ML) model. In some aspects, sidelink configuration information may indicate a range of candidate RSRP values from which a UE may select any value from within the range. In some aspects, sidelink configuration information may indicate a set of allowed RSRP values from which a UE may select the RSRP threshold value based on an output from the AI/ML model. In some aspects, the AI/ML model may be trained based on a dataset collected at the UE and/or based on a dataset collected at the network node and transferred to the UE. In some aspects, the AI/ML model may be trained on a serving cell RSRP measurement, a neighboring cell RSRP measurement, a serving cell signal-to-interference-plus-noise ratio (SINR) measurement, and/or a location of one or more UEs. Accordingly, the UE may transmit the sidelink SSB where an RSRP measurement satisfies the selected candidate RSRP threshold.

Particular aspects of the subject matter described in this disclosure can be implemented to realize one or more of the following potential advantages. In some examples, the described techniques can be used to more accurately determine and/or predict an RSRP threshold value according to the location of a UE within a cell of a network node, thus enabling the UE to transmit a sidelink SSB only when the UE is located in the cell edge of the network node. As a result, the UE may conserve power and/or reduce the network traffic that would otherwise result from the UE transmitting the sidelink SSB when the UE is located near the cell center of a network node. Additionally, by indicating a range or an allowed set of candidate RSRP threshold values, the network node may increase the accuracy of the set of candidate RSRP threshold values by including only values with a confirmed association with a cell edge. Additionally, by utilizing an AI/ML model for selection of a candidate RSRP value, the UE may increase the efficiency of sidelink SSB transmissions, where sidelink SSB may be transmitted when the UE is within a cell edge of a network node. For example, the AI/ML model may be trained on historical and/or current data associated with a cell edge of a network node, enabling the AI/ML model to increase accuracy in the selection of RSRP threshold values that determine or imply the boundaries of the cell edge.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

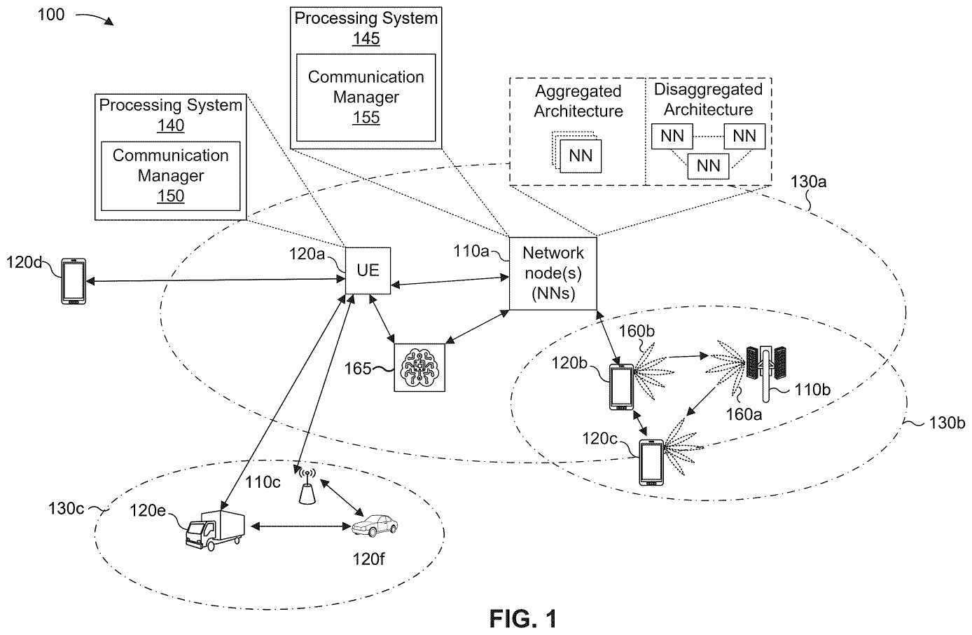

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, a UE 120d, a UE 120e, and a UE 120f. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

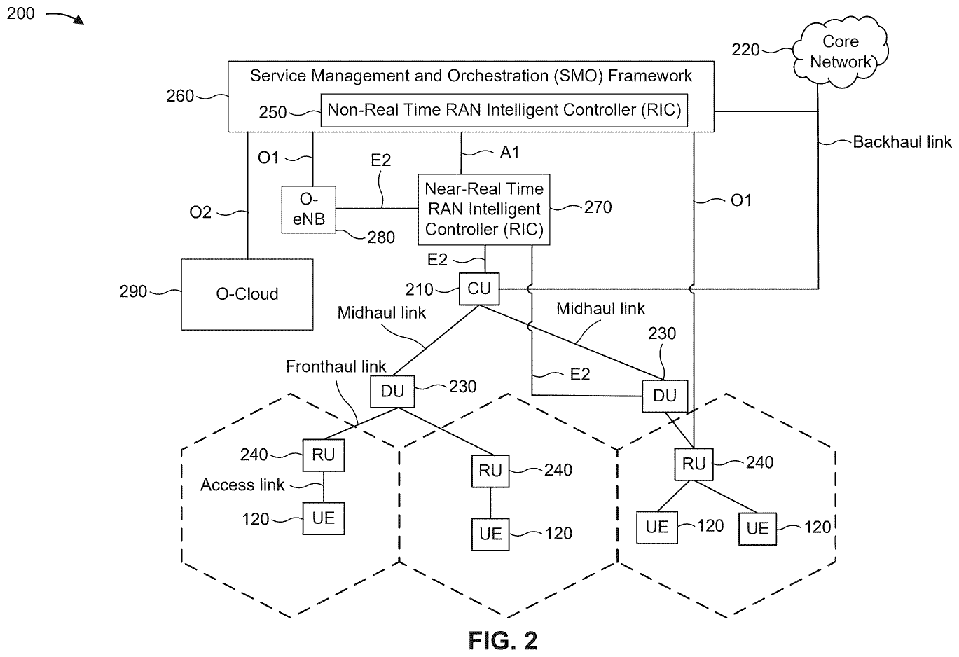

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some examples, two or more UEs 120 (for example, shown as UE 120a and UE 120d or the UE 120e and the UE 120f may communicate directly with one another using sidelink communications (for example, without communicating by way of a network node 110 as an intermediary). As an example, the UE 120a may directly transmit data, control information, or other signaling as a sidelink communication to the UE 120d. This is in contrast to, for example, the UE 120a first transmitting data in an uplink communication to a network node 110, which then transmits the data to the UE 120d in a downlink communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. For example, the cell 130c may include a V2X network supported by the network node 110c. In some examples, the network node 110c may be a roadside unit or other device deployed in the V2X network. In some other deployments and configurations, a UE 120 (instead of a network node 110) may perform, or collaborate or negotiate with one or more other UEs 120 to perform scheduling operations, resource selection operations, and/or other operations for sidelink communications. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

In some aspects, the UE 120 may include a communication manager 150. As described in more detail elsewhere herein, the communication manager 150 may receive, from a network node, a sidelink configuration indicating a set of candidate RSRP values for a threshold; select an RSRP value for the threshold from the set of candidate RSRP values based at least in part on an output from an AI/ML model; and transmit an SSB based at least in part on an RSRP measurement associated with a cell satisfying the threshold associated with the selected RSRP value. Additionally, or alternatively, the communication manager 150 may perform one or more other operations described herein.

In some aspects, the network node 110 may include a communication manager 155. As described in more detail elsewhere herein, the communication manager 155 may identify a set of candidate RSRP values for a threshold related to a sidelink SSB transmission; and transmit, to a UE, a sidelink configuration indicating the set of candidate RSRP values. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

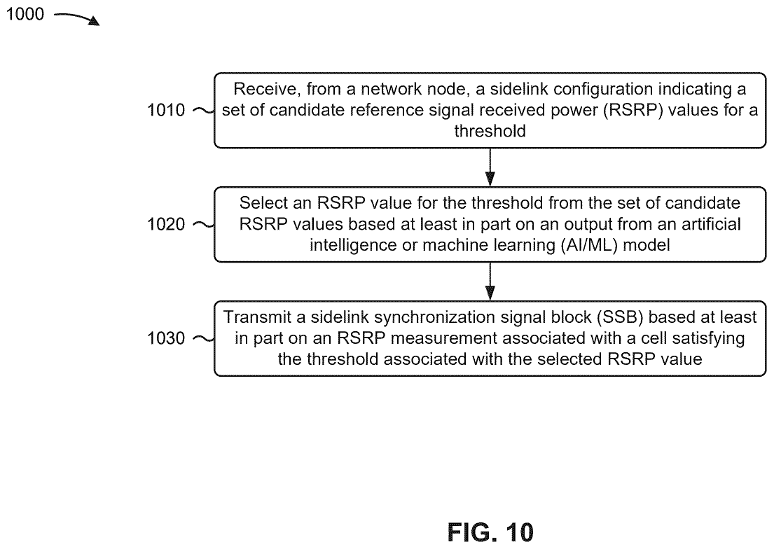

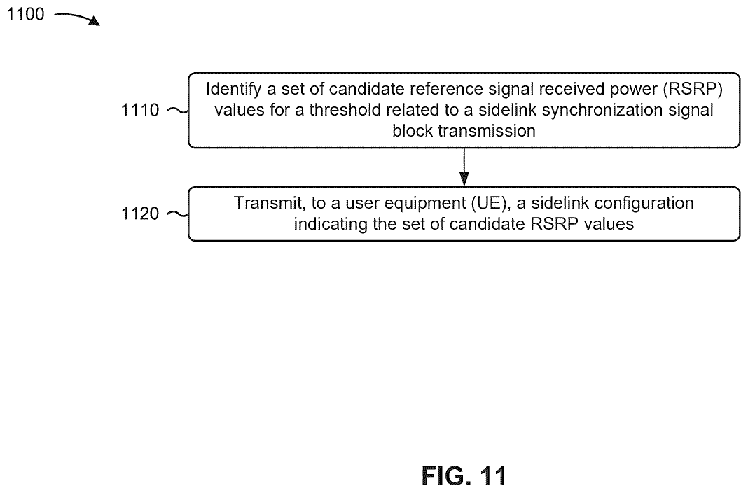

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with sidelink synchronization signal transmission, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

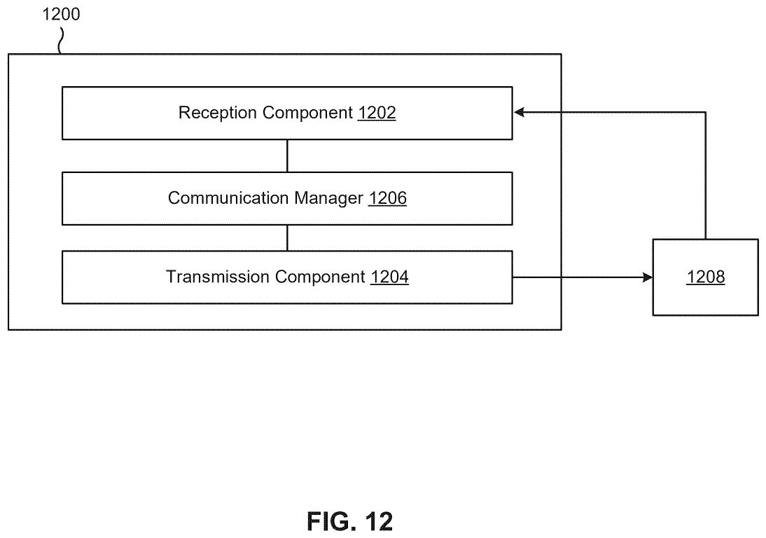

In some aspects, the UE 120 includes means for receiving, from a network node, a sidelink configuration indicating a set of candidate RSRP values for a threshold; means for selecting an RSRP value for the threshold from the set of candidate RSRP values based at least in part on an output from an AI/ML model; and/or means for transmitting a sidelink SSB based at least in part on an RSRP measurement associated with a cell satisfying the threshold associated with the selected RSRP value. The means for the UE 120 to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

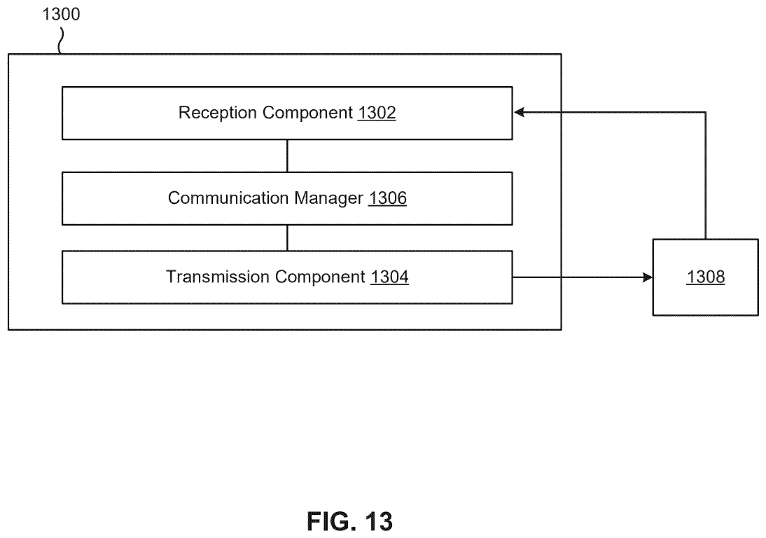

In some aspects, the network node 110 includes means for identifying a set of candidate RSRP values for a threshold related to a sidelink SSB transmission; and/or means for transmitting, to a UE, a sidelink configuration indicating the set of candidate RSRP values. The means for the network node 110 to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

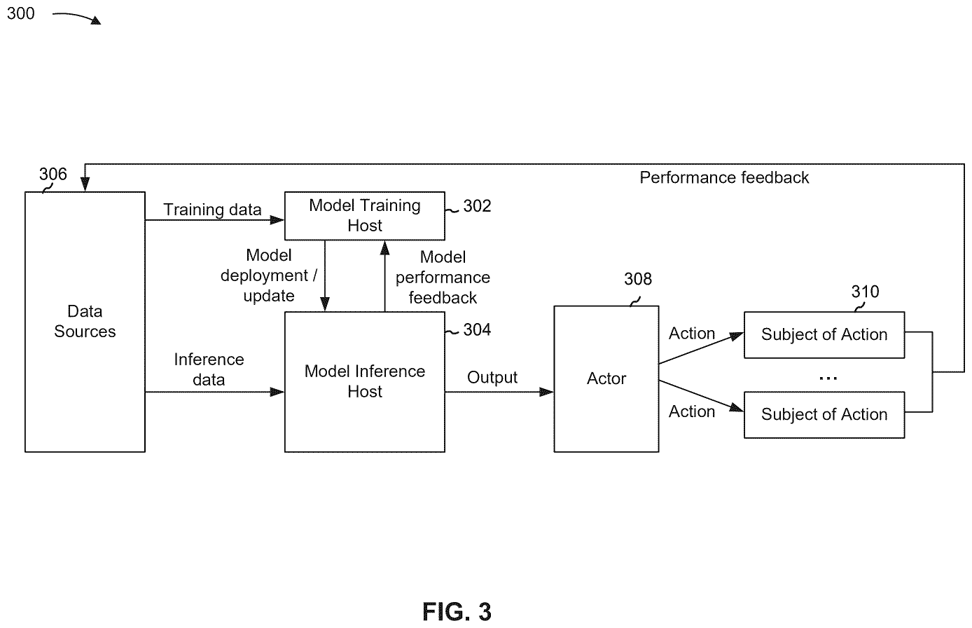

FIG. 3 is a diagram illustrating an example architecture 300 of a functional framework for radio access network (RAN) intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, sidelink communication, and/or coverage optimization, among other examples). In one example, as shown by the architecture 300, a functional framework for RAN intelligence may include multiple logical entities, such as a model training host 302, a model inference host 304, data sources 306, and an actor 308.

The model inference host 304 may be configured to run an AI/ML model based on inference data provided by the data sources 306, and the model inference host 304 may produce an output (e.g., a prediction) with the inference data input to the actor 308. The actor 308 may be an element or an entity of a core network or a RAN. For example, the actor 308 may be a UE, a network node, base station (e.g., a gNB), a CU, a DU, and/or an RU, among other examples. In addition, the actor 308 may also depend on the type of tasks performed by the model inference host 304, type of inference data provided to the model inference host 304, and/or type of output produced by the model inference host 304. For example, if the output from the model inference host 304 is associated with position determination, the actor 308 may be a UE, a DU or an RU. In some examples, the model inference host 304 may be hosted on the actor 308. For example, a UE may be the actor 308 and may host the model inference host 304. In some aspects, a UE (e.g., the actor 308) may be a data source 306. For example, the UE may perform a measurement (e.g., an NR measurement), may input the measurement to the AI/ML model at the model inference host 304 (or may provide the measurement to the model inference host 304), and may act based on an output of the AI/ML model (e.g., selecting an RSRP threshold value for determining whether a UE is located at a cell edge of a network node, where the RSRP threshold value is selected based on the output from the AI/ML model).

After the actor 308 receives an output from the model inference host 304, the actor 308 may determine whether to act based on the output. For example, if the actor 308 is a UE and the output from the model inference host 304 is associated with position information, the actor 308 may determine whether to report the position information, reconfigure a beam, among other examples. If the actor 308 determines to act based on the output, in some examples, the actor 308 may indicate the action to at least one subject of action 310.

The data sources 306 may also be configured for collecting data (e.g., RSRP values measured by the network node 110 and/or by the UE 120) that is used as training data for training an ML model or as inference data for feeding an ML model inference operation. For example, the data sources 306 may collect data from one or more core network and/or RAN entities, which may include the actor 308 or the subject of action 310, and provide the collected data to the model training host 302 for ML model training. In some aspects, the model training host 302 may be co-located with the model inference host 304 and/or the actor 308. For example, the actor 308 or the subject of action 310 may provide performance feedback associated with the beam configuration to the data sources 306, where the performance feedback may be used by the model training host 302 for monitoring or evaluating the ML model performance, such as whether the output (e.g., prediction) provided to the actor 308 is accurate. In some examples, the model training host 302 may monitor or evaluate ML model performance using a training position value, which may be provided by a node (e.g., a UE 120 or a network node 110), as described elsewhere herein. In some examples, if the output provided by the actor 308 is inaccurate (or the accuracy is below an accuracy threshold), then the model training host 302 may determine to modify or retrain the ML model used by the model inference host, such as via an ML model deployment/update.

As indicated above, FIG. 3 is provided as an example. Other examples may differ from what is described with regard to FIG. 3.

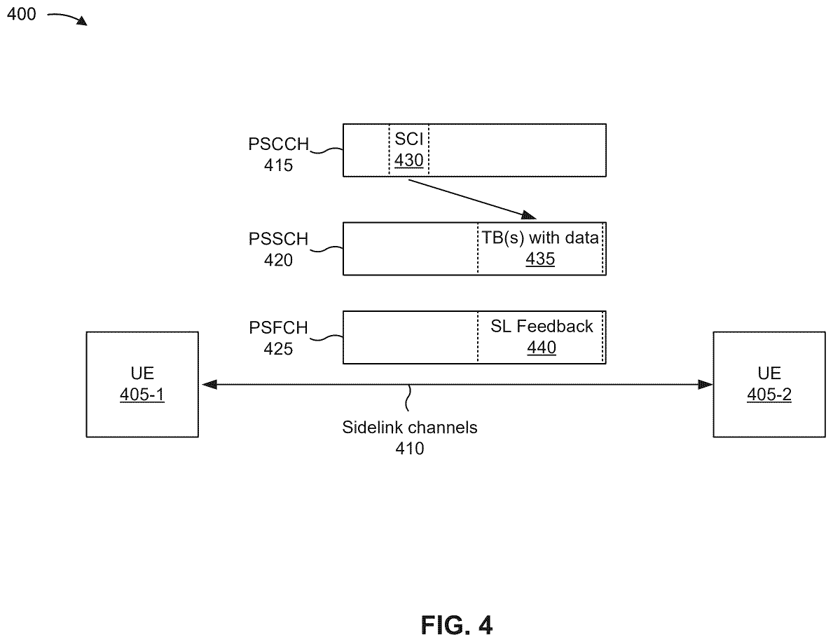

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing. Additionally, or alternatively, the UEs 405 may provide synchronization configuration information via sidelink SSB on a frequency used for sidelink communication in order to propagate timing and/or frequency references to enable sidelink communication.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure an RSRP parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

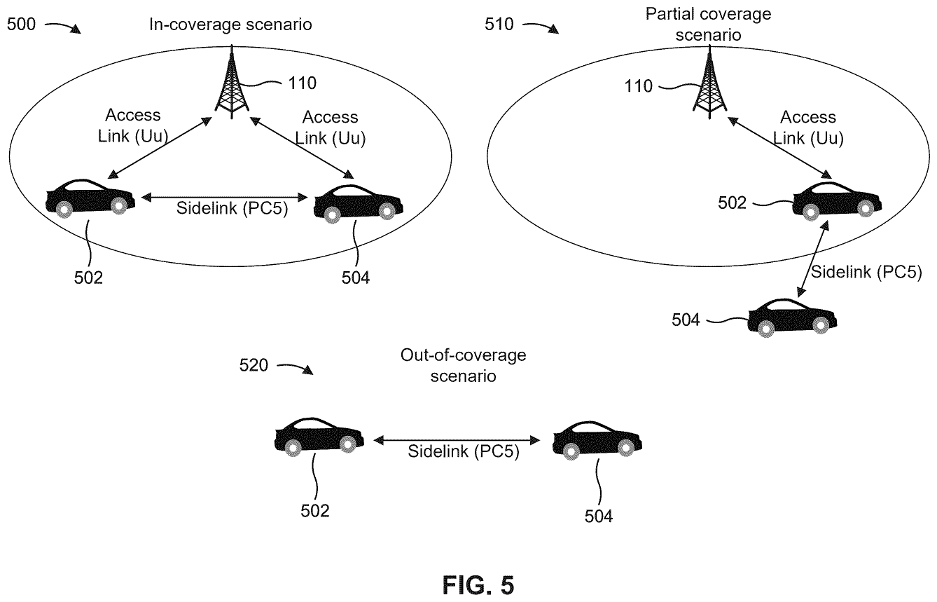

FIG. 5 is a diagram illustrating examples of sidelink communications in different coverage scenarios 500, 510, 520, in accordance with the present disclosure. For example, FIG. 5 illustrates an example of sidelink communications in an in-coverage scenario 500, an example of sidelink communications in a partial coverage scenario 510, and an example of sidelink communications in an out-of-coverage scenario 520.

As shown in FIG. 5, in the in-coverage scenario 500, a transmitter (Tx)/receiver (Rx) UE 502 and an Rx/Tx UE 504 may communicate with one another via a sidelink (e.g., a PC5 interface), as described above in connection with FIG. 4, and a network node 110 may communicate with the Tx/Rx UE 502 via a first access link and with the Rx/Tx UE 504 via a second access link (e.g., respective Uu interfaces). As shown, in the in-coverage scenario 500, the Tx/Rx UE 502 and the Rx/Tx UE 504 are both within the coverage of the network node 110, whereby sidelink communication between the Tx/Rx UE 502 and the Rx/Tx UE 504 may be performed in a centralized or network-controlled scheduling mode (e.g., Mode 1) where sidelink resources are scheduled by the network node 110, or in a distributed or autonomous scheduling mode (e.g., Mode 2) where the UEs 502/504 autonomously select sidelink resources from a configured sidelink resource pool based on a channel sensing mechanism.

In some examples, where the Tx/Rx UE 502 and the Rx/Tx UE 504 are associated and synchronized with the same network node 110, the Tx/Rx UE 502 and the Rx/Tx UE 504 may be indirectly synchronized with one another. Additionally, or alternatively, when a Tx/Rx UE 502 and a Rx/Tx UE 504 are respectively associated with different, asynchronous network nodes, the Tx/Rx UE 502 and the Rx/Tx UE 504 may synchronize with one another via a sidelink SSB transmission. For example, the sidelink SSB may be transmitted by the Tx/Rx UE 502 to the Rx/Tx UE 504 where the sidelink SSB transmission may be decoupled from data channel transmissions.

As further shown in FIG. 5, in the partial coverage scenario 510, a Tx/Rx UE 502 is within the coverage area of a network node 110, and an Rx/Tx UE 504 is outside the coverage area of the network node 110. In the partial coverage scenario 510, the Tx/Rx UE 502 and the Rx/Tx UE 504 may communicate with one another via a sidelink (e.g., a PC5 interface), and the network node 110 may communicate with the Tx/Rx UE 502 via an access link (e.g., a Uu interface). Accordingly, in the in-coverage scenario 510, the network node 110 may enable either the centralized scheduling mode or the distributed scheduling mode for the Tx/Rx UE 502 within the coverage area of the network node 110, and the Rx/Tx UE 504 that is out-of-coverage may use only the distributed scheduling mode. Furthermore, in the out-of-coverage scenario 520, the Tx/Rx UE 502 and the Rx/Tx UE 504 are outside the coverage area of any network node 110. Accordingly, in the out-of-coverage scenario 520, only the distributed scheduling mode can be used to enable sidelink communication between the Tx/Rx UE 502 and the Rx/Tx UE 504.

As described herein, when a UE is to perform a sidelink transmission, the sidelink transmission may be performed according to one or more sidelink procedures and/or using one or more transmission parameters that are configured to streamline a channel access scheme that sidelink UEs follow either in the centralized or network-controlled scheduling mode or in the distributed or autonomous scheduling mode. In general, all communication parameters (e.g., transmission parameters such as transmit power and/or DMRS pattern, and procedural parameters indicating whether certain sidelink features and/or procedures are enabled or disabled) are centrally selected or otherwise controlled by the network in the centralized scheduling mode (e.g., Mode 1). For example, in the centralized scheduling mode, a network node is aware of congestion, traffic conditions, interference, load, and/or other factors that may impact performance of the network node and the UEs within the coverage area of the network node, and the network node configures the sidelink communication parameters accordingly to optimize overall sidelink and/or cellular performance and/or per-UE performance.

On the other hand, in the distributed scheduling mode, there are various sidelink communication parameters that are independently or autonomously selected by a transmitting UE. For example, in the distributed scheduling mode, sidelink communication parameters may include globally configured parameters that have fixed values (e.g., a number of subchannels, a bandwidth of the subchannels, and/or a slot duration, among other examples) and locally configured parameters whose selection is left to the transmitting UE. For example, the locally configured parameters may include an MCS, a DMRS pattern, a transmit power, a maximum number of retransmissions for a given TB, a groupcast option 1 NACK distance (e.g., a distance over which a receiving UE can send a NACK for a sidelink transmission), and/or a beta parameter (e.g., related to coding associated with a transmitted waveform), among other examples. In some cases, the transmitting UE may select the locally configured parameters independently, possibly restricted over a set of allowed or permitted values, with the locally configured parameters having values that are selected by the UE in order to optimize performance of the UE with respect to one or more metrics that are typically application-dependent. For example, a transmitting UE may select an MCS and a maximum number of HARQ retransmissions to maximize packet reliability, maximize throughput, and/or minimize latency, among other examples. Furthermore, the transmitting UE may select the locally configured parameters according to a preconfigured scheme (e.g., using a default value that may be application-dependent, such as a default value for a basic safety message (BSM)) and/or using more sophisticated techniques based on on-the-fly (e.g., current or instantaneous) measurements such as a CBR or perceived congestion on a sidelink channel.

As described above, in cases where one or more transmitting UEs independently or autonomously select one or more locally configured sidelink communication parameters in the distributed scheduling mode, the transmitting UEs select the parameter values to optimize local performance with respect to one or more performance metrics. However, independent (selfish) selection of the sidelink communication parameters may result in suboptimal or unstable overall performance (e.g., by various UEs engaged in sidelink communication) and/or suboptimal or unstable per-UE performance. For example, when a sidelink transmission is performed using groupcast option 1, where only receiving UEs that are within a specified distance from the transmitting UE are permitted to send NACK feedback to trigger a retransmission, the sidelink transmission may be associated with a locally configured parameter that defines a NACK distance threshold. For example, the NACK distance threshold is typically associated with application reliability requirements, based on a distance over which a sidelink transmission needs to be reliably received (e.g., if a sidelink transmission needs to be reliably received by all vehicles within X meters from the transmitting UE, the NACK distance threshold may be set to a value equal to or greater than X meters).

At an extreme, when all UEs making an independent and selfish selection, every transmitting UE may select the largest allowable value for the NACK distance threshold in order to cover all possible reliability requirements (e.g., with respect to link distance) without having to perform any adaptation (e.g., to varying reliability requirements that may be required by transmissions corresponding to different applications). In this case, selecting the largest allowable value for the NACK distance threshold may result in many retransmissions being unnecessarily triggered for sidelinks that have little or no interest (e.g., very long distance links that are irrelevant for most applications), which may result in unnecessary congestion degrading overall sidelink performance (e.g., increasing collisions and/or packet losses) for all UEs. In contrast, if the NACK distance threshold were to be coordinated (e.g., different UEs select locally optimal values for the NACK distance threshold), system performance and individual UE performance may improve. For example, in a wireless network where all UEs operate using groupcast option 1 and select the same NACK distance threshold, an average packet reception rate (PRR) may be sensitive to the selected value for the NACK distance threshold. Ideally, overall system performance may be optimized by achieving a certain PRR (e.g., at least 90%) at a maximum possible distance. Accordingly, because overall (average system-wide) PRR performance is sensitive to the NACK distance threshold, an optimal value for the NACK distance threshold that achieves the best overall PRR performance at any given distance may differ from UE-specific reliability requirements. For example, if setting the NACK distance threshold to a value greater than 100 meters would result in a highest PRR at a 50 meter distance, some UEs may experience suboptimal performance if all UEs were to independently select a NACK distance threshold of 50 meters to maximize reliability at 50 meters. In this example, coordinating the NACK distance threshold such that all UEs use a NACK distance of at least 100 meters may improve overall and individual PRR performance. However, current wireless networks and/or wireless communication standards lack any mechanisms that may enable such coordination for sidelink operation performed in the distributed or autonomous scheduling mode (e.g., Mode 2 sidelink operation).

Accordingly, some aspects described herein relate to techniques and apparatuses associated with parameter-level coordination for sidelink communication in a distributed scheduling mode. For example, as described herein, a coordination node (e.g., a cloud entity or another suitable centralized node) may generate coordination information that indicates values and/or selection criteria for one or more locally configured sidelink communication parameters, which may generally include numerical values for one or more sidelink transmission parameters and/or sidelink procedure parameters (e.g., information that indicates whether one or more sidelink features or procedures are enabled or disabled). In some aspects, as described herein, the coordination node may select one or more locally configured sidelink communication parameters to be coordinated in the distributed scheduling mode, and may generate coordination information that indicates the values and/or other selection criteria associated with the coordinated sidelink parameters. For example, in some aspects, the sidelink communication parameters to be coordinated and/or the values or other selection criteria associated with the coordinated parameters may be selected by the coordination node to optimize or improve overall sidelink performance (e.g., to maximize the average or sum performance over the network). Furthermore, as described herein, the parameter-level coordination in the distributed scheduling mode may be simpler to achieve than the full coordination used in the centralized scheduling mode (which may be fundamentally impossible in cases where the distributed scheduling mode is used for out-of-coverage UEs). For example, the parameter-level coordination in the distributed scheduling mode may limit coordination to a curated set of parameters that have a key impact on overall system performance and/or per-UE performance and may be updated at a relatively slow rate.

As indicated above, FIG. 5 is provided as an example. Other examples may differ from what is described with regard to FIG. 5.

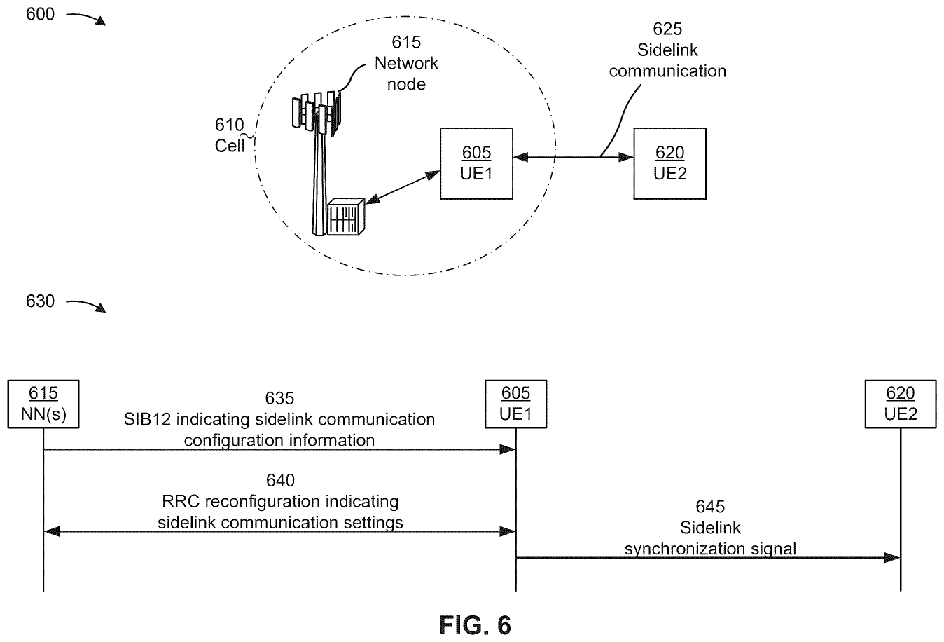

FIG. 6 is a diagram illustrating examples 600, 630 of sidelink communications, in accordance with the present disclosure.

As shown by reference number 600, a first UE 605 (shown as UE1) may be located within a cell 610 of a network node 615, and the first UE 605 may be in communication with the network node 615 via an access link. For example, the first UE 605 may be synchronized to the timing and/or frequency references of the network node 615. Additionally, a second UE 620 (shown as UE2) may be located outside of the cell 610 of the network node 615, and the second UE 620 may be in communication with the first UE 605 via sidelink communication 625. In some examples, the second UE 620 may not be synchronized to the timing and/or frequency references of the network node 615. For example, the second UE 620 may be synchronized with a different network node or the second UE 620 may be entirely unsynchronized with any network node. As a result, the first UE 605 may transmit a sidelink SSB to the second UE 620 in order to propagate the timing and/or frequency references of the network node 615 so that the first UE 605 and the second UE 620 may be synchronized.

As shown by reference number 630, a first UE 605 may establish a sidelink synchronization with a second UE 620. In some examples, the network node 615 and the first UE 605 may communicate with one another following an initial connection and configuration process (e.g., during a RACH procedure) between the network node 615 and the first UE 605.

As shown by reference number 635, the first UE 605 may receive a system information block (SIB) that indicates a sidelink communication configuration (e.g., SIB12) from the network node 615. As shown by reference number 640, the network node 615 and the first UE 605 may establish a connection via an RRC reconfiguration process, which may include a dedicated sidelink configuration procedure for the first UE 605 (e.g., the frequency used to transmit NR sidelink communication may be included in sl-FreqInfoToAddModList in sl-ConfigDedicatedNR within an RRCReconfiguration message). As shown by reference number 645, after the connection is established between the first UE 605 and the network node 615, the first UE 605 may transmit a sidelink synchronization signal to the second UE 620. For example, the sidelink synchronization signal may include sidelink synchronization information (e.g., an SSB) and/or master information block (MIB) sidelink information that may enable the first UE 605 to propagate the network node 615 timing and/or frequency references to enable the first UE 605 and the second UE 620 to be synchronized, thereby enabling sidelink communication between the first UE 605 and the second UE 620.

In some examples, only a subset of UEs 605 within a cell of a network node 615 may transmit a sidelink SSB. For example, a first UE 605 located near the cell center of the network node 615 may not transmit the sidelink SSB. Rather, in an optimal configuration, only UEs 605 located within a cell edge or within a certain proximity to the cell edge of a network node 615 may be configured to transmit a sidelink SSB to enable synchronized sidelink communication with one or more UEs 620 that may be located outside of the cell of the network node 615 (e.g., UEs 620 that are not synchronized to the timing and/or frequency references of the network node 615). By utilizing only UEs 605 located at or near the cell edge to transmit the sidelink SSB, power consumption of UEs 605 located in the cell center may be reduced and overall network traffic may be reduced. For example, where UEs 605 located in the cell center transmit the sidelink SSB to UEs 620 located outside of the cell, the sidelink SSB transmissions increase power consumption by the transmitting UE and increase network traffic within and/or around the cell.

In some examples, the cell edge may be determined or implied based on a single, fixed RSRP threshold value (e.g., based on whether an RSRP value measured by a UE 605 satisfies the fixed RSRP threshold value). However, because the shape and/or coverage of a cell may be amorphous (e.g., may change depending on location and over time), determining the cell edge based on a single, fixed RSRP threshold value may not provide an accurate representation of the actual cell edge.

Accordingly, various aspects described herein relate generally to a network node configuring a set of candidate RSRP threshold values from which a UE may select an RSRP value to be used in determining whether to transmit sidelink SSB. Some aspects more specifically relate to the network node indicating a range of candidate RSRP threshold values or indicating an enumerated set of RSRP threshold values. In some aspects, the candidate RSRP threshold values may be cell-specific. In some aspects, the network node may transmit the configuration of the candidate RSRP threshold values to the UE via a cell-specific message or via a UE-dedicated message. In some aspects, the candidate RSRP threshold values may be received by the UE as part of a configuration from an operation, administration, and maintenance (OAM) entity. In some aspects, the candidate RSRP threshold values may be determined by the network node based on UE reports of measured RSRP values. In some aspects, the UE may select the RSRP threshold value from the set of candidate RSRP threshold values based on an output from an artificial intelligence or machine learning (AI/ML) model. In some aspects, sidelink configuration information may indicate a range of candidate RSRP values from which a UE may select the RSRP threshold value from any value within the range. In some aspects, sidelink configuration information may indicate a set of allowed RSRP values from which a UE may select the RSRP threshold value based on an output from the AI/ML model. In some aspects, the AI/ML model may be trained based on a dataset collected at the UE and/or based on a dataset collected at the network node and transferred to the UE. In some aspects, the AI/ML model may be trained on a serving cell RSRP measurement, a neighboring cell RSRP measurement, a serving cell signal-to-interference-plus-noise ratio (SINR) measurement, and/or locations of one or more UEs. Accordingly, the UE may transmit the sidelink SSB where an RSRP measurement satisfies the selected candidate RSRP threshold.

Particular aspects of the subject matter described in this disclosure can be implemented to realize one or more of the following potential advantages. In some examples, the described techniques can be used to more accurately determine and/or predict an RSRP threshold value according to the location of a UE within a cell of a network node, thus enabling the UE to transmit a sidelink SSB only when the UE is located in the cell edge of the network node. As a result, the UE may conserve power and/or reduce the network traffic that would otherwise result from the UE transmitting the sidelink SSB when the UE is located near the cell center of a network node. Additionally, by indicating a range or an allowed set of candidate RSRP threshold values, the network node may increase the accuracy of the set of candidate RSRP threshold values by including only values with a confirmed association with a cell edge. Additionally, by utilizing an AI/ML model for selection of a candidate RSRP value, the UE may increase the efficiency of sidelink SSB transmissions, where sidelink SSB may be transmitted when the UE is within a cell edge of a network node. For example, the AI/ML model may be trained on historical and/or current data associated with a cell edge of a network node, enabling the AI/ML model to increase accuracy in the selection of RSRP threshold values that determine or imply the boundaries of the cell edge.

As indicated above, FIG. 6 is provided as an example. Other examples may differ from what is described with respect to FIG. 6.

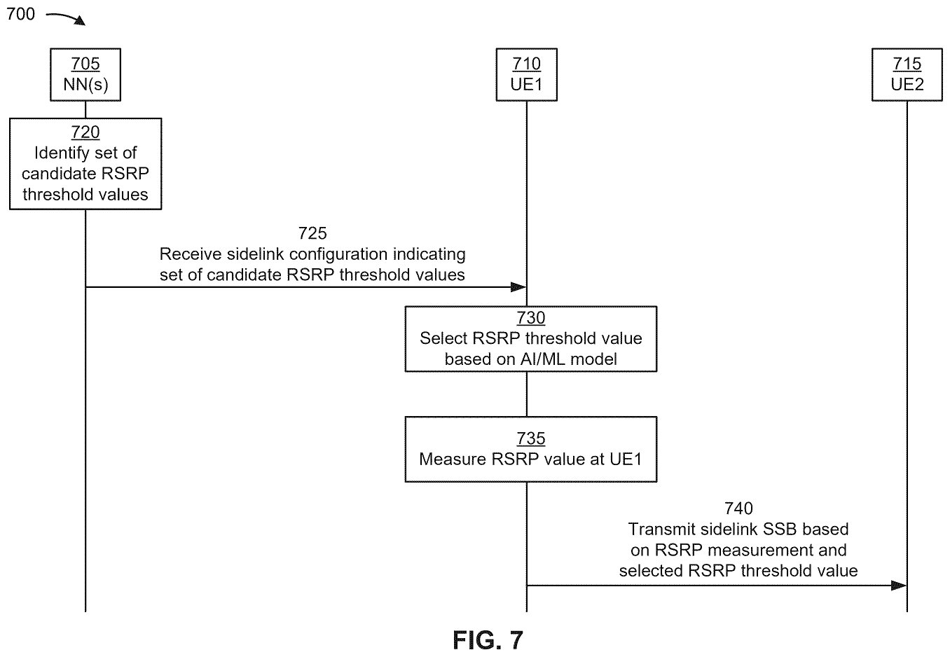

FIG. 7 is a diagram illustrating an example 700 associated with sidelink synchronization signal transmission, in accordance with the present disclosure. As shown in FIG. 7, a network node 705 and a first UE 710 (shown as UE1) may communicate with one another via an access link, and the first UE 710 and a second UE 715 (shown as UE2) may communicate with one another via a sidelink. Additionally, or alternatively, the second UE 715 may be out of coverage of a network node 705 (e.g., unsynchronized to any network node 705), or the second UE 715 may be synchronized to a network node other than network node 705.

As shown by reference number 720, the network node 705 may identify a set of candidate RSRP threshold values. In some aspects, the set of candidate RSRP threshold values may be received as part of a configuration from an OAM entity. For example, in a cell, the cell edge RSRP values may be measured, determined, and/or estimated during deployment of the wireless network and/or the network node 705. For example, measurement and/or sensing equipment may be utilized across a cell area to acquire measurements that may be used to derive RSRP values at different locations within the cell. In some aspects, the candidate RSRP threshold values may be determined based on the cell edge RSRP values and configured by and received from an OAM entity. For example, the cell edge of a cell may be determined to be in a first range (e.g., approximately −115 decibel milliwatts (dBm) to approximately −90 dBm) based on the measured or estimated RSRP values, and the set of candidate RSRP threshold values may be in a second range (e.g., approximately −110 dBm to approximately −85 dBm). For example, the range of candidate RSRP threshold values may be narrower than, wider than, or the same as the range of the measured cell edge RSRP values.

Additionally, or alternatively, the candidate RSRP threshold values may be determined and/or estimated by the wireless network and/or the network node 705 based on RSRP measurement values reported from one or more UEs 120. For example, one or more UEs in a cell of the network node 705 may report their measured RSRP values (e.g., for sidelink synchronization purposes, for mobility purposes as part of a measurement report, for reporting CSI or performing beam management, as part of a minimization of drive test (MDT) configuration, or the like). The network node 705 may store the collected RSRP data and identify candidate RSRP values associated with a cell edge based on the RSRP data. For example, an RSRP value may be associated with a cell edge if the RSRP measurement is associated with at least one mobility event (e.g., a handover event or the like).

As shown by reference number 725, the network node 110 may transmit, and the first UE 710 may receive, sidelink configuration information indicating the set of candidate RSRP threshold values. In some aspects, the set of candidate RSRP threshold values may be cell-specific (e.g., different cells may have different RSRP threshold values due to different coverage). In some aspects, the sidelink configuration may be transmitted to the first UE 710 via a cell-specific message (e.g., an SIB) or via a UE-dedicated message (e.g., an RRC configuration).

In some aspects, the network node 705 may indicate, to the first UE 710, a range of candidate RSRP threshold values (e.g., a minimum value and a maximum value for the candidate RSRP threshold values) or an enumerated set of allowed RSRP threshold values from which the first UE 710 may select. For example, the network node may configure a syncTxThreshICMin parameter and a syncTxThreshICMax parameter to indicate the range of candidate RSRP threshold values. Additionally, or alternatively, the network node 705 may configure a syncTxThreshIC parameter to indicate an enumerated set of candidate RSRP threshold values.

As shown by reference number 730, the first UE 710 may select an RSRP threshold value based on an AI/ML model. In some aspects, the AI/ML model may be a UE-side AI/ML model (e.g., an AI/ML model hosted on the first UE 710) trained based on data collected at the first UE 710. In some aspects, the UE-side AI/ML model may be trained based on one or more data types, including serving cell RSRP values, neighboring cell RSRP values, serving cell SINR values, and/or locations (e.g., geographic coordinates) associated with the first UE 710. In some aspects, the output of the UE-side AI/ML model may include an RSRP threshold value that the first UE 710 may compare to measured RSRP values to determine whether to transmit a sidelink SSB. For example, an input to the UE-side AI/ML model may include an RSRP measurement of the serving cell of the first UE 710 and an RSRP measurement from one or more neighboring cells (e.g., one or more strongest neighboring cell RSRP measurements), and an output of the UE-side AI/ML model may determine the RSRP threshold value that the first UE 710 compares to measured RSRP values to determine whether to transmit the sidelink SSB.

Additionally, or alternatively, the AI/ML model may be a network-side AI/ML model trained on data collected at the network node 705 and/or at additional network nodes 110. In some aspects, the network-side AI/ML model may be trained based on data reported by one or more UEs 110, where such data may include serving cell RSRP values, neighboring cell RSRP values, serving cell SINR values, and/or UE 110 locations (e.g., geographic coordinates). For example, the network-side AI/ML model may be trained based on the first UE 710 serving cell RSRP measurement and the first UE 710 location as an input, and the network-side AI/ML model may output one or more predictions associated with cell edge RSRP values. In some aspects, the network-side AI/ML model may be transferred from the network node 705 to the first UE 710, where the first UE 710 may perform inferences to select an RSRP threshold value (e.g., using the first UE 710 RSRP measurement value and location to select an RSRP threshold value).

In some aspects, the network node 705 may indicate, to the first UE 710, a range of candidate RSRP threshold values (e.g., a minimum value and a maximum value for the candidate RSRP threshold values). Where the first UE 710 receives the indication of a range of candidate RSRP values from which to select the RSRP threshold value, the first UE 710 may select any value within the range of values (e.g., based on the output from the AI/ML model). In some aspects, the first UE 710 may be configured to select from a subset of values within the range of candidate RSRP threshold values (e.g., according to an integer, a step function, an offset value, or the like). By indicating a range of candidate RSRP threshold values according to a minimum RSRP threshold value and a maximum RSRP threshold value, the network node 705 may reduce transmission overhead (e.g., transmission data size) relative to the network node 705 indicating an enumerated set of candidate RSRP threshold values (e.g., with three or more candidate RSRP threshold values).

Additionally, or alternatively, in some aspects, the network node 705 may indicate, to the first UE 710, the set of candidate RSRP threshold values according to a set of allowed RSRP values (e.g., a set of enumerated candidate RSRP threshold values), and the first UE 710 may be configured to select any value from the set of allowed RSRP values. By indicating a set of allowed RSRP values from which the first UE 710 may select an RSRP threshold value, the network node 705 may include only values that have a confirmed association with a cell edge.

As shown by reference number 735, the first UE 710 may measure RSRP at the first UE 710. For example, the first UE 710 may derive a measured RSRP value by averaging the power received from multiple resource elements that transmit a reference signal.

As shown by reference number 740, the first UE 710 may transmit a sidelink SSB based on the RSRP measurement satisfying (e.g., being lower than) the selected RSRP threshold value. For example, where the RSRP measured by the first UE 710 satisfies (e.g., is lower than) the selected RSRP threshold value, the first UE 710 may transmit the sidelink SSB and the transmitted sidelink SSB may propagate a time and/or frequency reference to a second UE 715 or may otherwise enable synchronization between the first UE 710 and the second UE 715. Additionally, or alternatively, the transmitted sidelink SSB may be received by one or more additional UEs 715 located outside of the cell of the network node 705. For example, two or more receiving UEs 715 may communicate with one another, where the synchronization signal and the data channel transmission may be decoupled.

Accordingly, by providing a set of candidate RSRP threshold values and by utilizing an AI/ML model to enable selection of an RSRP threshold value, a UE may more accurately and efficiently determine whether to transmit a sidelink SSB. By utilizing a UE-side AI/ML model, the dataset on which the AI/ML model is trained may be informed by multiple RSRP and/or SINR measurements and may include location information of the first UE 710, thereby increasing the accuracy of RSRP threshold values that determine or imply the boundaries of the cell edge. By utilizing a network-side AI/ML model, the dataset on which the AI/ML model is trained may be broadened to include data from multiple UEs located in a serving cell and/or in a neighboring cell, thereby increasing the accuracy in the selection of RSRP threshold values that determine or imply the boundaries of the cell edge. Additionally, by indicating a range or an allowed set of candidate RSRP threshold values, the network node may increase the accuracy of the set of candidate RSRP threshold values by including only values with a confirmed association with a cell edge and may reduce the transmission overhead (e.g., transmission data size) relative to indicating an enumerated set of candidate threshold values.

As indicated above, FIG. 7 is provided as an example. Other examples may differ from what is described with respect to FIG. 7.

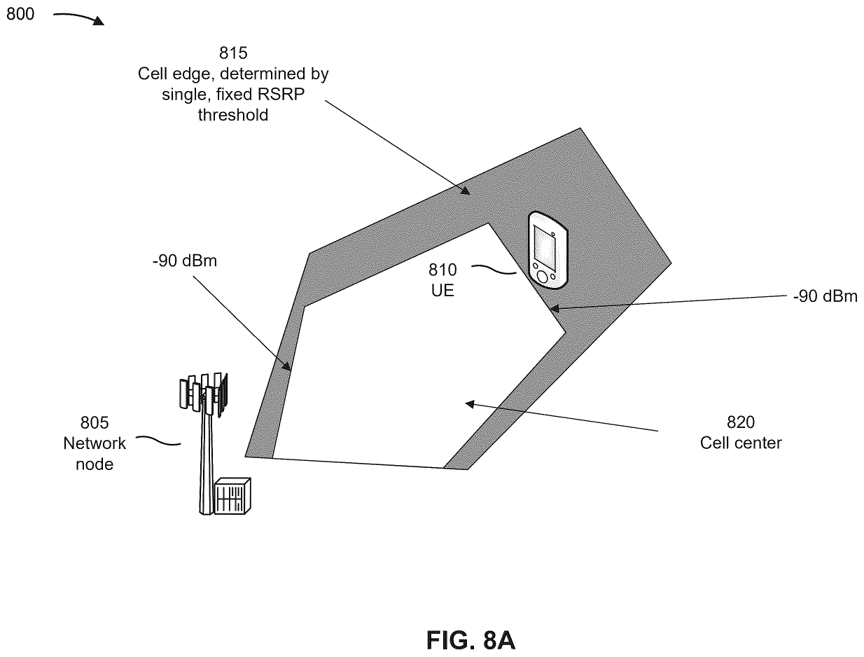

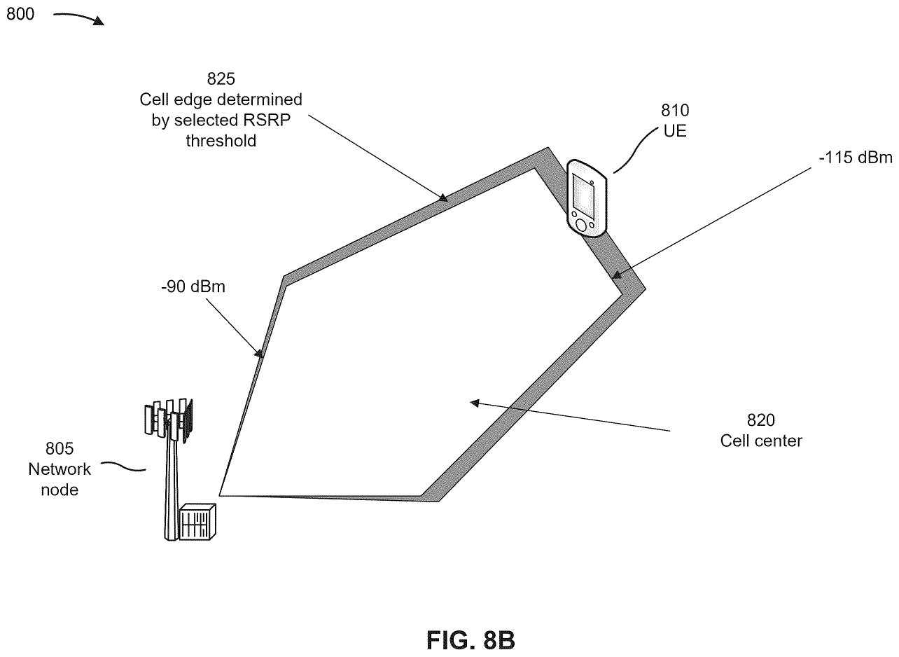

FIGS. 8A-8B are diagrams illustrating examples 800 associated with sidelink synchronization signal transmission, in accordance with the present disclosure. As shown in FIGS. 8A-8B, example 800 includes communication between a network node 805 and a UE 810. In some aspects, the network node 805 and the UE 810 may be included in a wireless network, such as wireless network 100. The network node 805 and the UE 810 may communicate via a wireless access link, which may include an uplink and a downlink.

As shown in FIG. 8A, a network node 805 may provide wireless network coverage in a geographic area (e.g., a cell). A UE 810 may be configured to transmit a sidelink SSB when the UE 810 is located within or in relative proximity to a cell edge of the network node 805, where the cell edge may be determined by an RRC parameter (e.g., cell coverage and/or UE measurement configurations, handover information, or other similar parameters) configured by the network node 805. For example, a cell edge may be determined by an RSRP threshold value that is configured by the network node 805. In such an example, the UE 810 may transmit the sidelink SSB if a measured RSRP at the UE 810 (e.g., from the serving cell of the network node 805) satisfies (e.g., is below) the configured RSRP threshold value. In contrast, where the measured RSRP at the UE 810 does not satisfy (e.g., is equal to or above) the configured RSRP threshold value, the UE 810 does not transmit sidelink SSB.

However, in some examples, the network node 805 configures a single, fixed (e.g., static) RSRP threshold value for determining (or implying) the boundaries of the cell edge 815 and thereby controlling the conditions under which the UE 810 transmits the sidelink SSB. In some examples, the fixed RSRP threshold value configuration may apply to multiple UEs 810 that are within coverage of a cell of the network node 805.

For example, only UEs 810 located within or in relative proximity to the cell edge 815 (denoted by gray shading) may be optimally positioned to transmit a sidelink SSB, where UEs that receive sidelink SSB from a UE 810 in the cell edge area are more likely to be out-of-coverage of the network node.

However, the coverage of a cell may be amorphous, where the cell shape and/or coverage may change depending on the location and/or over time. For example, an ideal cell shape may be a regular hexagonal or a 3-sector cell shape, which may not exist in practical deployment. As a result, the cell edge 815 determined by a single, fixed RSRP threshold (e.g., a static RSRP threshold value) may not represent the actual cell edge 815. For example, where a single, fixed RSRP threshold value is configured in order to accommodate cell edge areas having higher RSRP measurements, a relatively larger RSRP threshold value may be configured. Accordingly, UEs 810 located in the cell center (e.g., located at a relatively increased distance from the cell edge) may perform unnecessary sidelink SSB transmissions due to an inaccurate representation of the cell edge. For example, UEs that receive the sidelink SSB from a UE in a cell center may also be located within or near the cell center, and thus may obtain synchronization information directly from the network node. Accordingly, it may be inefficient and unnecessary for a UE 810 located within the cell center to transmit sidelink SSB.

For example, where the single, fixed RSRP threshold value is −90 dBm and the UE 810 measures RSRP values to be less than −90 dBm, the UE 810 may transmit sidelink SSB based on the measured RSRP satisfying the RSRP threshold (e.g., a measured RSRP of −100 dBm), despite the UE 810 being located near the cell center relative to the cell edge 815. As a result, the UE 810 may unnecessarily transmit sidelink SSB, resulting in increased power consumption and increased network traffic.

As shown in FIG. 8B, where the cell edge 825 is determined based on the UE 810 selecting an RSRP threshold value from a set of candidate RSRP values and based on an AI/ML model according to some aspects described herein, the cell edge 825 determined by the selected RSRP threshold may more accurately represent the cell edge 825 relative to the cell edge 815 determined by a single, fixed RSRP threshold. For example, as the shape and/or coverage of a cell changes depending on location and/or time, the cell edge 825 determined by a selected RSRP threshold (e.g., based on where the UE 810 is located within the cell) may provide a more consistently accurate representation of the cell edge 825.

In some aspects, the UE 810 may select an RSRP threshold value using the AI/ML model, which may select an RSRP value when the UE is within or near the cell center 820 and may select a different RSRP value when the UE 810 is within or near the cell edge 815. Accordingly, the measured RSRP is more likely to fail to satisfy the threshold (e.g., the UE 810 does not transmit the sidelink SSB) when the UE 810 is within or near the cell center 820. Additionally, the measured RSRP is more likely to satisfy the threshold (e.g., the UE 810 transmits the sidelink SSB) when the UE 810 is within or near the cell edge. For example, where the selected RSRP threshold value is in a range from −90 dBm to −115 dBm and the UE 810 measures an RSRP value that satisfies this threshold, the UE 810 may transmit sidelink SSB. For example, there is an increased probability that only UEs 810 located at a sufficient proximity to the cell edge 815 may transmit sidelink communications (e.g., sidelink SSB), thereby reducing the power consumption and the network traffic that may result from unnecessary sidelink communication transmissions from UEs 810 located at insufficient proximity to a cell edge.

As indicated above, FIGS. 8A-B are provided as examples. Other examples may differ from what is described with respect to FIGS. 8A-8B.

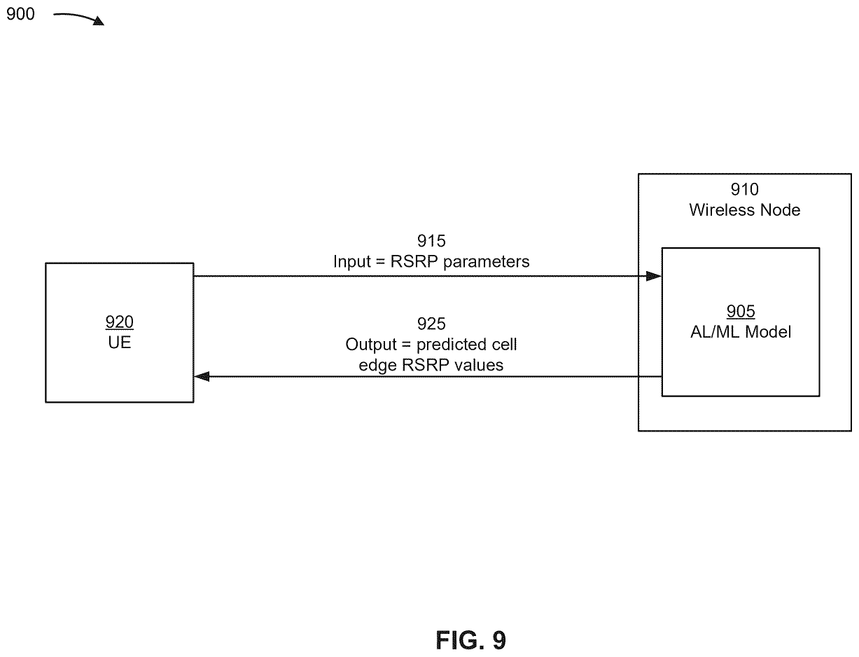

FIG. 9 is a diagram illustrating an example 900 of an AI/ML based model for determining an RSRP threshold value, in accordance with the present disclosure. As shown in FIG. 9, an AI/ML model 905 may be deployed at or on a wireless node 910, which may correspond to the UE 120 and/or the network node 110 described elsewhere herein. For example, a model inference host may be deployed at, or on, a UE 120 for use in generating one or more UE-side predictions that may be indicated in a prediction report sent to a network node, or the model inference host may be deployed at, or on, a network node 110, for use in generating one or more network-side predictions that may be indicated in a prediction results indication sent to a UE 120. The AI/ML model 905 may enable the wireless node to determine one or more inferences or predictions based on data input to the AI/ML model 905. Additionally, or alternatively, the AI/ML model 905 may be hosted on the network node 110, where the AI/ML model may be transferred from the network node 110 to the UE 120 in order for the UE 120 to perform inferencing (e.g., using the UE 120 RSRP measurement and location to inform selection of an RSRP threshold value).

For example, as shown by reference number 915, an input to the AI/ML model 905 may include RSRP parameters (e.g., measurements associated with RSRP values, including serving cell RSRP values, neighboring cell RSRP values, serving cell SINR values, and/or the locations of one or more UEs). Additionally, or alternatively, the input to the AI/ML model may include RSRP data collected from multiple UEs 120 and/or RSRP data identifying cell edge RSRP values (e.g., an RSRP value measured during a mobility event). In some aspects, the AI/ML model 905 may be hosted at the UE 920. In some other aspects, the AI/ML model 905 may be hosted at the network node 110 and the RSRP values may be reported by the UE 920 to the network node 110.

As shown by reference number 925, the AI/ML model 905 may output one or more predictions. The one or more predictions may include predicted measurement values (e.g., predicted RSRP measurement values) associated with the UE 920. This may enable the UE 920 to select an RSRP threshold value (from a set of candidate RSRP threshold values) that more accurately represents the shape and/or coverage of a cell in the network node 110 relative to a single, fixed RSRP threshold value. This type of prediction may enable the UE 920 to more accurately determine whether to transmit sidelink communications (e.g., SSBs) depending on a measured RSRP value satisfying the selected RSRP threshold value.

In some aspects, the UE 920 may utilize the output of an AI/ML model to select an RSRP threshold value that accurately represents the cell edge of the network node 110 relative to a single, fixed RSRP value representing the cell edge of the network node 110. Accordingly, the selection of an RSRP threshold value based on the AI/ML model may increase the probability that only UEs 920 located in sufficient proximity to the cell edge may transmit sidelink communications, thereby reducing the power consumption and network traffic that may result from sidelink communication transmissions made by UEs 920 not located in sufficient proximity to the cell edge.

As indicated above, FIG. 9 is provided as an example. Other examples may differ from what is described with regard to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with sidelink synchronization signal transmission.

As shown in FIG. 10, in some aspects, process 1000 may include receiving, from a network node, a sidelink configuration indicating a set of candidate RSRP values for a threshold (block 1010). For example, the UE (e.g., using reception component 1202 and/or communication manager 1206, depicted in FIG. 12) may receive, from a network node, a sidelink configuration indicating a set of candidate RSRP values for a threshold, as described above.

As further shown in FIG. 10, in some aspects, process 1000 may include selecting an RSRP value for the threshold from the set of candidate RSRP values based at least in part on an output from an AI/ML model (block 1020). For example, the UE (e.g., using communication manager 1206, depicted in FIG. 12) may select an RSRP value for the threshold from the set of candidate RSRP values based at least in part on an output from an AI/ML model, as described above.

As further shown in FIG. 10, in some aspects, process 1000 may include transmitting a sidelink SSB based at least in part on an RSRP measurement associated with a cell satisfying the threshold associated with the selected RSRP value (block 1030). For example, the UE (e.g., using transmission component 1204 and/or communication manager 1206, depicted in FIG. 12) may transmit a sidelink SSB based at least in part on an RSRP measurement associated with a cell satisfying the threshold associated with the selected RSRP value, as described above.

Process 1000 may include additional aspects, such as any single aspect or any combination of aspects described below and/or in connection with one or more other processes described elsewhere herein.

In a first aspect, the sidelink configuration indicates the set of candidate RSRP values according to a minimum value and a maximum value that define a range for the threshold.

In a second aspect, alone or in combination with the first aspect, selecting the RSRP value includes selecting any RSRP value from within the range defined by the minimum value and the maximum value.

In a third aspect, alone or in combination with one or more of the first and second aspects, the sidelink configuration indicates the set of candidate RSRP values according to a set of allowed RSRP values.

In a fourth aspect, alone or in combination with one or more of the first through third aspects, selecting the RSRP value includes selecting the RSRP value from the set of allowed RSRP values.

In a fifth aspect, alone or in combination with one or more of the first through fourth aspects, the AI/ML model is trained based at least in part on at least one dataset collected at the UE.

In a sixth aspect, alone or in combination with one or more of the first through fifth aspects, the AI/ML model is trained based at least in part on at least one training dataset collected at the network node.

In a seventh aspect, alone or in combination with one or more of the first through sixth aspects, selecting the RSRP value includes providing one or more of a serving cell RSRP measurement, a neighboring cell RSRP measurement, a serving cell signal-to-interference-plus-noise ratio measurement, or a UE location to the AI/ML model as an input.

In an eighth aspect, alone or in combination with one or more of the first through seventh aspects, process 1000 includes transmitting, to the network node, an indication of the selected RSRP value.

In a ninth aspect, alone or in combination with one or more of the first through eighth aspects, process 1000 includes transmitting, to the network node, the RSRP measurement.

In a tenth aspect, alone or in combination with one or more of the first through ninth aspects, the sidelink configuration is received via an SIB.

In an eleventh aspect, alone or in combination with one or more of the first through tenth aspects, the sidelink configuration is received via an RRC configuration message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with sidelink synchronization signal transmission.

As shown in FIG. 11, in some aspects, process 1100 may include identifying a set of candidate RSRP values for a threshold related to a sidelink SSB (block 1110). For example, the network node (e.g., using communication manager 1306, depicted in FIG. 13) may identify a set of candidate RSRP values for a threshold related to a sidelink SSB transmission, as described above.

As further shown in FIG. 11, in some aspects, process 1100 may include transmitting, to a UE, a sidelink configuration indicating the set of candidate RSRP values (block 1120). For example, the network node (e.g., using transmission component 1304 and/or communication manager 1306, depicted in FIG. 13) may transmit, to a UE, a sidelink configuration indicating the set of candidate RSRP values, as described above.

Process 1100 may include additional aspects, such as any single aspect or any combination of aspects described below and/or in connection with one or more other processes described elsewhere herein.

In a first aspect, the set of candidate RSRP values is indicated according to a minimum value and a maximum value that define a range for the threshold.

In a second aspect, alone or in combination with the first aspect, the sidelink configuration includes an AI/ML model trained at least in part on at least one dataset collected at the UE.

In a third aspect, alone or in combination with one or more of the first and second aspects, the sidelink configuration includes an AI/ML model trained at least in part on at least one dataset collected at the network node.

In a fourth aspect, alone or in combination with one or more of the first through third aspects, process 1100 includes receiving, from the UE, a selected RSRP value associated with a threshold.

In a fifth aspect, alone or in combination with one or more of the first through fourth aspects, the sidelink configuration is transmitted via an SIB.

In a sixth aspect, alone or in combination with one or more of the first through fifth aspects, the sidelink configuration is transmitted via an RRC configuration message.

In a seventh aspect, alone or in combination with one or more of the first through sixth aspects, process 1100 includes receiving, from a plurality of UEs in a cell, a plurality of RSRP measurements, and identifying at least one cell edge RSRP value from the plurality of RSRP measurements, wherein one or more RSRP values in the set of candidate RSRP values are based at least in part on the at least one cell edge RSRP value.

In an eighth aspect, alone or in combination with one or more of the first through seventh aspects, identifying the at least one cell edge RSRP value is based on a subset of the plurality of RSRP measurements associated with at least one mobility event.

In a ninth aspect, alone or in combination with one or more of the first through eighth aspects, process 1100 includes receiving a configuration indicating the set of candidate RSRP values from an OAM entity.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the UE.

In some aspects, the apparatus 1200 may be configured to perform one or more operations described herein in connection with FIGS. 7-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a network node, a sidelink configuration indicating a set of candidate RSRP values for a threshold. The communication manager 1206 may select an RSRP value for the threshold from the set of candidate RSRP values based at least in part on an output from an AI/ML model. The transmission component 1204 may transmit a sidelink SSB based at least in part on an RSRP measurement associated with a cell satisfying the threshold associated with the selected RSRP value.

The transmission component 1204 may transmit, to the network node, an indication of the selected RSRP value. The transmission component 1204 may transmit, to the network node, the RSRP measurement.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the network node.

In some aspects, the apparatus 1300 may be configured to perform one or more operations described herein in connection with FIGS. 7-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network node described above in connection with FIG. 1, such as a radio, one or more RF chains, one or more transceivers, or one or more modems, each of which may in turn be coupled with one or more antennas of the network node. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The communication manager 1306 may identify a set of candidate RSRP values for a threshold related to a sidelink SSB transmission. The transmission component 1304 may transmit, to a UE, a sidelink configuration indicating the set of candidate RSRP values.

The reception component 1302 may receive, from the UE, a selected RSRP value associated with a threshold. The reception component 1302 may receive, from a plurality of UEs in a cell, a plurality of RSRP measurements.

The communication manager 1306 may identify at least one cell edge RSRP value from the plurality of RSRP measurements, wherein one or more RSRP values in the set of candidate RSRP values are based at least in part on the at least one cell edge RSRP value. The reception component 1302 may receive a configuration indicating the set of candidate RSRP values from an OAM entity.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a user equipment (UE), comprising: receiving, from a network node, a sidelink configuration indicating a set of candidate reference signal received power (RSRP) values for a threshold; selecting an RSRP value for the threshold from the set of candidate RSRP values based at least in part on an output from an artificial intelligence or machine learning (AI/ML) model; and transmitting a sidelink synchronization signal block (SSB) based at least in part on an RSRP measurement associated with a cell satisfying the threshold associated with the selected RSRP value.
Aspect 2: The method of Aspect 1, wherein the sidelink configuration indicates the set of candidate RSRP values according to a minimum value and a maximum value that define a range for the threshold.
Aspect 3: The method of Aspect 2, wherein selecting the RSRP value includes selecting any RSRP value from within the range defined by the minimum value and the maximum value.
Aspect 4: The method of any of Aspects 1-3, wherein the sidelink configuration indicates the set of candidate RSRP values according to a set of allowed RSRP values.
Aspect 5: The method of Aspect 4, wherein selecting the RSRP value includes selecting the RSRP value from the set of allowed RSRP values.
Aspect 6: The method of any of Aspects 1-5, wherein the AI/ML model is trained based at least in part on at least one dataset collected at the UE.
Aspect 7: The method of any of Aspects 1-6, wherein the AI/ML model is trained based at least in part on at least one training dataset collected at the network node.
Aspect 8: The method of any of Aspects 1-7, wherein selecting the RSRP value includes providing one or more of a serving cell RSRP measurement, a neighboring cell RSRP measurement, a serving cell signal-to-interference-plus-noise ratio measurement, or a UE location to the AI/ML model as an input.
Aspect 9: The method of any of Aspects 1-8, further comprising: transmitting, to the network node, an indication of the selected RSRP value.
Aspect 10: The method of any of Aspects 1-9, further comprising: transmitting, to the network node, the RSRP measurement.
Aspect 11: The method of any of Aspects 1-10, wherein the sidelink configuration is received via a system information block (SIB).
Aspect 12: The method of any of Aspects 1-11, wherein the sidelink configuration is received via a radio resource control (RRC) configuration message.
Aspect 13: A method of wireless communication performed by a network node, comprising: identifying a set of candidate reference signal received power (RSRP) values for a threshold related to a sidelink synchronization signal block transmission; and transmitting, to a user equipment (UE), a sidelink configuration indicating the set of candidate RSRP values.
Aspect 14: The method of Aspect 13, wherein the set of candidate RSRP values is indicated according to a minimum value and a maximum value that define a range for the threshold.
Aspect 15: The method of any of Aspects 13-14, wherein the sidelink configuration includes an AI/ML model trained at least in part on at least one dataset collected at the UE.
Aspect 16: The method of Aspect 15, wherein the sidelink configuration includes an AI/ML model trained at least in part on at least one dataset collected at the network node.
Aspect 17: The method of any of Aspects 13-16, further comprising: receiving, from the UE, a selected RSRP value associated with a threshold.
Aspect 18: The method of any of Aspects 13-17, wherein the sidelink configuration is transmitted via a system information block (SIB).
Aspect 19: The method of any of Aspects 13-18, wherein the sidelink configuration is transmitted via a radio resource control (RRC) configuration message.
Aspect 20: The method of any of Aspects 13-19, further comprising: receiving, from a plurality of UEs in a cell, a plurality of RSRP measurements; and identifying at least one cell edge RSRP value from the plurality of RSRP measurements, wherein one or more RSRP values in the set of candidate RSRP values are based at least in part on the at least one cell edge RSRP value.
Aspect 21: The method of Aspect 20, wherein identifying the at least one cell edge RSRP value is based on a subset of the plurality of RSRP measurements associated with at least one mobility event.
Aspect 22: The method of any of Aspects 13-21, further comprising: receiving a configuration indicating the set of candidate RSRP values from an operations, administration, and maintenance (OAM) entity.
Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.
Aspect 24: An apparatus for wireless communication at a device, the apparatus comprising one or more memories and one or more processors coupled to the one or more memories, the one or more processors configured to cause the device to perform the method of one or more of Aspects 1-22.
Aspect 25: An apparatus for wireless communication, the apparatus comprising at least one means for performing the method of one or more of Aspects 1-22.
Aspect 26: A non-transitory computer-readable medium storing code for wireless communication, the code comprising instructions executable by one or more processors to perform the method of one or more of Aspects 1-22.
Aspect 27: A non-transitory computer-readable medium storing a set of instructions for wireless communication, the set of instructions comprising one or more instructions that, when executed by one or more processors of a device, cause the device to perform the method of one or more of Aspects 1-22.
Aspect 28: A device for wireless communication, the device comprising a processing system that includes one or more processors and one or more memories coupled with the one or more processors, the processing system configured to cause the device to perform the method of one or more of Aspects 1-22.
Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, a sidelink configuration indicating a set of candidate reference signal received power (RSRP) values for a threshold;
select an RSRP value for the threshold from the set of candidate RSRP values based at least in part on an output from an artificial intelligence or machine learning (AI/ML) model; and
transmit a sidelink synchronization signal block (SSB) based at least in part on an RSRP measurement associated with a cell satisfying the threshold associated with the selected RSRP value.

2. The UE of claim 1, wherein the sidelink configuration indicates the set of candidate RSRP values according to a minimum value and a maximum value that define a range for the threshold.

3. The UE of claim 2, wherein the one or more processors, to cause the UE to select the RSRP value, are configured to cause the UE to select any RSRP value from within the range defined by the minimum value and the maximum value.

4. The UE of claim 1, wherein the sidelink configuration indicates the set of candidate RSRP values according to a set of allowed RSRP values.

5. The UE of claim 4, wherein the one or more processors, to cause the UE to select the RSRP value, are configured to cause the UE to select the RSRP value from the set of allowed RSRP values.

6. The UE of claim 1, wherein the one or more processors, to cause the UE to select the RSRP value, are configured to cause the UE to provide one or more of a serving cell RSRP measurement, a neighboring cell RSRP measurement, a serving cell signal-to-interference-plus-noise ratio measurement, or a UE location to the AI/ML model as an input.

7. The UE of claim 1, wherein the one or more processors are further configured to cause the UE to:
transmit, to the network node, an indication of the selected RSRP value.

8. The UE of claim 1, wherein the one or more processors are further configured to cause the UE to:
transmit, to the network node, the RSRP measurement.

9. A network node for wireless communication, comprising:
one or more memories; and
one or more processors, coupled to the one or more memories, configured to cause the network node to:
identify a set of candidate reference signal received power (RSRP) values for a threshold related to a sidelink synchronization signal block transmission; and
transmit, to a user equipment (UE), a sidelink configuration indicating the set of candidate RSRP values.

10. The network node of claim 9, wherein the set of candidate RSRP values is indicated according to a minimum value and a maximum value that define a range for the threshold.

11. The network node of claim 9, wherein the sidelink configuration is transmitted via a system information block (SIB).

12. The network node of claim 9, wherein the sidelink configuration is transmitted via a radio resource control (RRC) configuration message.

13. The network node of claim 9, wherein the one or more processors are further configured to cause the network node to:
receive, from a plurality of UEs in a cell, a plurality of RSRP measurements; and
identify at least one cell edge RSRP value from the plurality of RSRP measurements, wherein one or more RSRP values in the set of candidate RSRP values are based at least in part on the at least one cell edge RSRP value.

14. The network node of claim 13, wherein identifying the at least one cell edge RSRP value is based on a subset of the plurality of RSRP measurements associated with at least one mobility event.

15. A method of wireless communication performed by a user equipment (UE), comprising:
receiving, from a network node, a sidelink configuration indicating a set of candidate reference signal received power (RSRP) values for a threshold;
selecting an RSRP value for the threshold from the set of candidate RSRP values based at least in part on an output from an artificial intelligence or machine learning (AI/ML) model; and
transmitting a sidelink synchronization signal block (SSB) based at least in part on an RSRP measurement associated with a cell satisfying the threshold associated with the selected RSRP value.

16. The method of claim 15, wherein the sidelink configuration indicates the set of candidate RSRP values according to a minimum value and a maximum value that define a range for the threshold.

17. The method of claim 16, wherein selecting the RSRP value includes selecting any RSRP value from within the range defined by the minimum value and the maximum value.

18. The method of claim 15, wherein the sidelink configuration indicates the set of candidate RSRP values according to a set of allowed RSRP values.

19. The method of claim 18, wherein selecting the RSRP value includes selecting the RSRP value from the set of allowed RSRP values.

20. The method of claim 15, wherein the AI/ML model is trained based at least in part on at least one dataset collected at the UE.

21. The method of claim 15, wherein the AI/ML model is trained based at least in part on at least one training dataset collected at the network node.

22. The method of claim 15, wherein the sidelink configuration is received via a system information block (SIB).

23. The method of claim 15, wherein the sidelink configuration is received via a radio resource control (RRC) configuration message.

24. A method of wireless communication performed by a network node, comprising:
identifying a set of candidate reference signal received power (RSRP) values for a threshold related to a sidelink synchronization signal block transmission; and
transmitting, to a user equipment (UE), a sidelink configuration indicating the set of candidate RSRP values.

25. The method of claim 24, wherein the set of candidate RSRP values is indicated according to a minimum value and a maximum value that define a range for the threshold.

26. The method of claim 24, wherein the sidelink configuration includes an AI/ML model trained at least in part on at least one dataset collected at the UE.

27. The method of claim 26, wherein the sidelink configuration includes an AI/ML model trained at least in part on at least one dataset collected at the network node.

28. The method of claim 24, further comprising:
receiving, from the UE, a selected RSRP value associated with a threshold.

29. The method of claim 24, further comprising:
receiving, from a plurality of UEs in a cell, a plurality of RSRP measurements; and
identifying at least one cell edge RSRP value from the plurality of RSRP measurements, wherein one or more RSRP values in the set of candidate RSRP values are based at least in part on the at least one cell edge RSRP value.

30. The method of claim 24, further comprising:
receiving a configuration indicating the set of candidate RSRP values from an operations, administration, and maintenance (OAM) entity.
